(19) United States
(12) Patent Application Publication
(10) Pub. No.: US 2013/0336870 A1
(43) Pub. Date: Dec. 19, 2013

(54) Advanced Tritium System for Separation of Tritium from Radioactive Wastes and Reactor Water in Light Water Systems

(71) Applicant: Kurion, Inc., Oak Ridge, TN (US)

(72) Inventors: Mark S. Denton, Knoxville, TN (US); Walter T. Shmayda, Rochester, NY (US)

(73) Assignee: Kurion, Inc., Oak Ridge, TN (US)

(21) Appl. No.: 13/863,206

(22) Filed: Apr. 15, 2013

Related U.S. Application Data
(63) Continuation-in-part of application No. 13/079,331, filed on Apr. 4, 2011.
(60) Provisional application No. 61/320,515, filed on Apr. 2, 2010.

(51) Int. Cl. B01D 59/30

(52) U.S. Cl. CPC B01D 59/30
USPC 423/249; 422/162

(57) ABSTRACT

Systems, methods, and processes for a high throughput, low concentration processing of low activity tritiated light water include the electrolysis of at least some of the tritiated water to produce hydrogen and tritium gas. The hydrogen and tritium gas produced by electrolysis in some cases are combined with heated water vapor to increase throughput and passed through a liquid phase catalytic exchange column, which generally includes a catalyst that includes palladium coated with a hydrophobic polymer. As the hydrogen and tritium gas, along with heated water vapor, rise through the LPCE column, the tritium is retained on the catalyst. Deionized wash water passes down the column (i.e., in the opposite direction of the flow of the hydrogen gas and heated water vapor) and carries the retained tritium out of the LPCE column. Useful in separating tritium from radioactive waste materials and from the water from nuclear reactors.

### CROSS-REFERENCE TO RELATED APPLICATIONS

This Application is a continuation-in-part of U.S. application Ser. No. 13/079,331, filed Apr. 4, 2011, which claims the benefit under 35 U.S.C. §119(e) of U.S. Provisional Application 61/320,5.15, filed Apr. 2, 2010.

### STATEMENT REGARDING FEDERALLY-SPONSORED RESEARCH OR DEVELOPMENT

Not Applicable

### BACKGROUND OF THE INVENTION

1. Field of Invention

The present invention relates generally to the treatment of radioactive waste and in particular to the separation of tritium from radioactive waste materials.

2. Description of the Related Art

Tritium is a radioactive isotope of hydrogen with a half-life of approximately 12.3 years. As tritium is both a radioactive contaminant and a potentially useful material for numerous scientific and commercial applications, the generation of tritium in pressurized water reactors (PWRs) is a matter of vital interest. Normal reactor operations produce quantities of tritiated water. In particular, the use of boron as a moderator within reactor systems naturally leads to the production of tritium and to the presence of tritium-containing water molecules both within the water used for cooling the reactor and within water used in storage pools for radioactive waste materials.

Available public water treatment processes remove many radioactive contaminants but are ineffective for tritium. Tritium is one of several radioactive isotopes that, over time, concentrate in organic systems and enter the food chain, possibly with adverse environmental and public health effects. Tritium contamination of the groundwater in the vicinity of nuclear power stations, including PWRs, has led to public outcry and negative publicity for the nuclear power industry. This could be particularly important, for example, at the site of a nuclear incident. Clearly, it would be advantageous to have methods, systems and apparatuses for the separation and concentration of tritium from light water used in PWRs and from water and liquids isolated from radioactive waste materials. (Herein, “light water” is used to refer to tritiated water, and especially HTO, and in opposition to “heavy water,” or D₂O, which is used in other nuclear applications.) The capability to separate tritium from reactor water and from radioactive waste materials is important for clean, safe, and secure radioactive waste management, which in turn is important for the safe and cost-effective use of nuclear power.

### BRIEF SUMMARY OF THE INVENTION

Disclosed herein are systems, methods, and apparatuses for separating tritium from radioactive materials and the water from nuclear reactors. In particular, the present general inventive concept, in some of its several embodiments, includes system and processes for high throughput treatment of water from reactor systems to concentrate and separate tritium from the reactor water. Of particular interest here is the development of a high throughput, low concentration system for volume reduction, as opposed to a low throughput, high concentration system for tritium product generation. Some embodiments of the present general inventive concept involve the reaction of tritiated hydrogen gases with water in the presence of a catalyst (often a palladium catalyst) in a catalytic exchange column, yielding a more concentrated and purified tritiated water product.

In some of its various embodiments, the present general inventive concept includes an advanced tritium system (ATS) for the separation of tritium. An ATS receives water from a light water reactor or from radioactive waste treatment system. When it enters the ATS, the water contains tritium isotopes, primarily in the form of tritiated water (e.g. HTO), where at least one of the protonic hydrogen atoms of the water molecule has been replaced by a tritium atom. The water with tritiated water passes into an electrolyzer—generally an alkaline electrolyzer, although other electrolyzers are contemplated—where the tritiated water is broken up by electrolysis into a combination of oxygen gas (O₂) and hydrogen gas comprising a number of hydrogen isotopes and isotope combinations (e.g. H₂, HT, T₂). The oxygen gas is diverted and discharged from the ATS, while the hydrogen gas with tritium is directed to a gas purifier, where various contaminants entrained in the gas, such as KOH or another substance from the electrolyzer, are removed from the gas. The hydrogen gas passes from the gas purifier into a catalytic exchange column; in some embodiments, the hydrogen gas leaving the gas purifier first passes through a heater or a humidifier, or both, before entering the catalytic exchange column. Within the catalytic exchange column, tritium is separated from protonic hydrogen. Hydrogen gas, including gas molecules with tritium constituents, enters the bottom of the catalytic exchange column and rises through the height of the catalytic exchange column. Generally, the hydrogen gas with tritium has been heated before it enters the catalytic exchange column. Substantially simultaneously, purified (distilled or at least deionized) water from a purified water source is fed into the top of the catalytic exchange column and allowed to trickle down. The catalytic exchange column is packed with granulated palladium or a similar catalyst. When the rising hydrogen gas with tritium encounters the falling purified water in the presence of the catalyst within the catalytic exchange column, the hydrogen gas with tritium and the purified water react to yield tritiated water (e.g., HTO) and hydrogen gas that is substantially free of tritium isotopes (i.e., “detritiated hydrogen”). The detritiated hydrogen is vented from the catalytic exchange column, while the tritiated water exits the catalytic exchange column and proceeds to a holding tank. This concentrated, substantially pure hydrogen can then be used as a fuel source. In many embodiments, the tritiated water in the holding tank is fed back into the electrolyzer in order to repeat the process of electrolysis and catalytic tritium separation, thereby yielding a tritiated water product with a higher concentration of tritium. Otherwise, the tritiated water proceeds from the holding tank to storage or other disposition (e.g., waste stabilization and disposal). Passing tritiated water from a nuclear reactor, or from radioactive waste, through an ATS such as the one illustrated in FIG. 3 and outlined above results in a product of concentrated tritiated water. The ATS greatly reduces or eliminates the volume of water that includes tritium. In some embodiments of the present general inventive concept, tritiated water is passed through multiple catalytic exchange columns in series. Passing the tritiated water through multiple catalytic exchange columns more thoroughly separates protonic hydrogen from tritium and yields a purer, more concentrated final tritium product and/or minimizes the volume of tritium-contaminated waste water. This also minimizes or eliminates the environmental discharge of this contaminated water.

In some embodiments of the present general inventive concept, a system for high throughput separation and concentration of tritium from tritiated waste water in light water nuclear reactors includes an electrolysis system to etectrolyze tritiated waste water to produce oxygen gas, hydrogen gas and tritium gas, a heater to heat water vapor, a liquid phase catalytic exchange column to receive a mixture of hydrogen gas and tritium gas from said electrolysis system and heated water vapor from said heater, said liquid phase catalytic exchange column including a catalyst to retain tritium gas from said mixture as said mixture passes through said liquid phase catalytic exchange column, a deionized water source to provide deionized wash water to said liquid phase catalytic exchange column in order to remove said tritium from said catalyst, so that said deionized wash water and said tritium emerge from said liquid phase catalytic exchange column as a concentrated tritium waste product a gaseous exhaust subsystem to carry away hydrogen gas and water vapor as gaseous exhaust from said liquid phase catalytic exchange column.

In some embodiments, said catalyst includes palladium.

In some embodiments, said catalyst includes palladium coated with a hydrophobic material.

In some embodiments, said catalyst includes palladium coated with a hydrophobic polymer.

In some embodiments, said catalyst includes palladium coated with a fluoropolymer.

In some embodiments, said catalyst includes palladium coated with a polytetrafluoroethylene.

Some embodiments further include a tritium monitor to monitor the tritium content of the gaseous exhaust within said gaseous exhaust subsystem.

Some embodiments further include a condenser to condense at least some of the gaseous exhaust.

Some embodiments further include a stabilization subsystem for treating said concentrated tritium waste product.

In some embodiments of the present general inventive concept, a method for high throughput separation and concentration of tritium from tritiated waste water in light water nuclear reactors includes electrolyzing tritiated water to produce hydrogen and tritium gas, combining hydrogen and tritium gas produced by electrolysis with heated water vapor to produce a mixture, passing the mixture through a liquid phase catalytic exchange column that includes a catalyst configured to retain tritium from the mixture, passing deionized wash water through said liquid phase catalytic exchange column to remove the tritium from said catalyst, collecting the tritium and the deionized wash water as a high activity tritium waste product, and expelling water vapor and hydrogen gas as effluent.

In some embodiments, said catalyst includes palladium.

In some embodiments, said catalyst includes palladium coated with a hydrophobic material.

In some embodiments, said catalyst includes palladium coated with a hydrophobic polymer.

In some embodiments, said catalyst includes palladium coated with a fluoropolymer.

In some embodiments, said catalyst includes palladium coated with a polytetrafluoroethylene.

In some embodiments, a method further includes monitoring the tritium content of the effluent with a tritium monitor.

In some embodiments, a method further includes condensing at least some of the effluent.

In some embodiments, a method further includes stabilizing the high activity tritium waste product.

### BRIEF DESCRIPTION OF THE DRAWINGS

The above-mentioned and additional features of the invention will become more clearly understood from the following detailed description of the invention read together with the drawings in which:

FIG. 1 is a block diagram illustrating an example of a system for processing radioactive waste materials that includes an ATS for separating tritium from liquid radioactive waste material;

FIG. 2 is a block diagram illustrating an example embodiment of the present general inventive concept in which an ATS is used for separating tritium from the water used to cool a nuclear reactor;

FIG. 3 is a block diagram illustrating an example embodiment of an ATS according to the present general inventive concept, including a catalytic exchange column;

FIG. 4 is a block diagram illustrating an example embodiment of the present general inventive concept in which an ATS includes an electrolysis system, a column, and a monitor to monitor the expulsion of di-tritiated hydrogen; and

FIG. 5 is a block diagram illustrating an example embodiment of the present general inventive including a system to recover tritium gas from concentrated tritiated water.

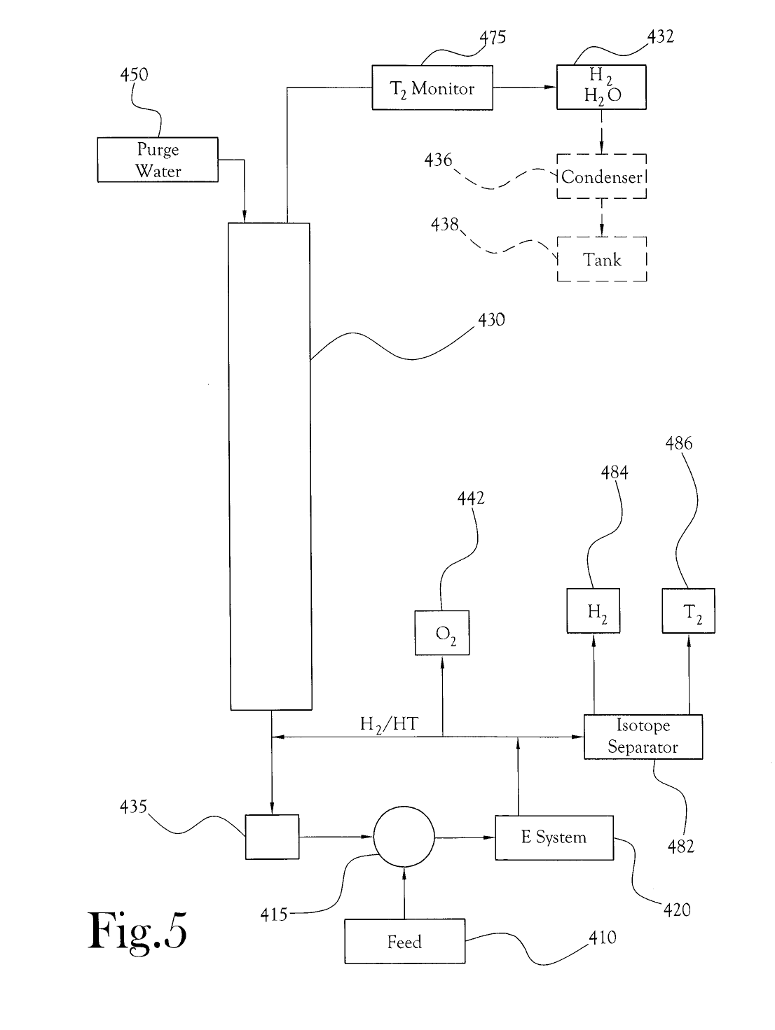

### DETAILED DESCRIPTION OF THE INVENTION

The present general inventive concept, in some of its embodiments, includes processes and methods for the separation, isolation, or removal (collectively “separation”) of tritium from radioactive waste. In particular, the present general inventive concept, in some of its several embodiments, includes systems and processes for high throughput treatment of water from reactor systems to concentrate and separate tritium from the reactor water.

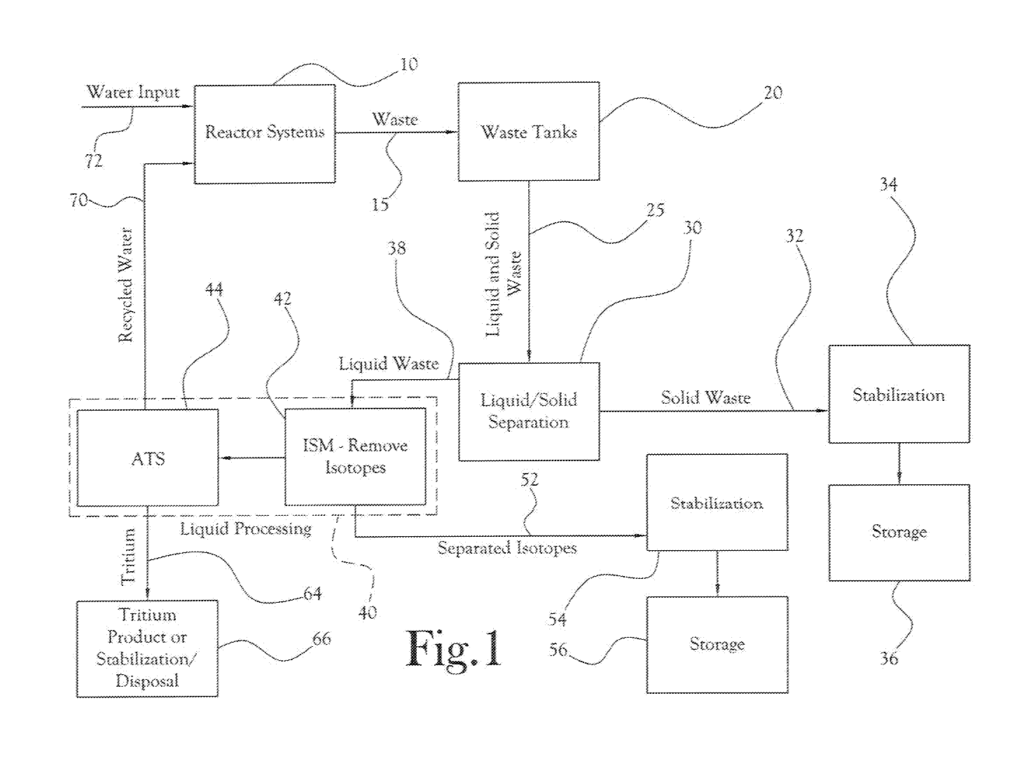

Turning to the figures, FIG. 1 illustrates an example embodiment of a larger system within which an advanced tritium system (ATS) for tritium separation is a component. As shown in the illustration, radioactive waste material from a nuclear reactor 16 is conveyed 15 first to waste tanks 20, where the waste material is kept submerged in water; as a result of storing radioactive waste, the water itself comes to contain a concentration of radioactive isotopes. The waste material, which at this stage includes both liquid and solid wastes, is conveyed 25 from the waste tanks 20 to a liquid/solid separation system 30 where liquid wastes (including the water from the waste tanks 20) are separated from the solid wastes. From the liquid/solid, separation system 30, the solid wastes proceed 32 to stabilization 34 and storage 36. It is possible that, in some instances, not all of the moisture or liquid mixed with the solid wastes will be separated from the solid wastes by the liquid/solid separation system 30, in which case the stabilization and storage of those wastes will proceed differently.

From the liquid/solid separation system 30, liquid wastes that are substantially free of solid waste material proceed 38 to a liquid processing system 40. In some embodiments, such as the one illustrated in FIG. 1, the liquid processing system 40 comprises an isotope-specific-media-based system 42 for the separation of specific isotopes and an ATS 44 for the separation or removal of tritium from the liquid wastes. Separated isotopes 52 removed by isotope-specific media (ISM)from the liquid wastes are stabilized 54 and moved to storage 56 or other disposition (with the final disposition or storage conditions often dependent upon the specific isotope involved). Tritium removed from the liquid wastes proceeds 64 to its own disposition 66. The liquid (mostly water), now substantially free of specified radioactive isotopes and tritium, usually is recycled 70 into the reactor 10, where it is combined with other water 72 fed into the reactor 10. In some embodiments, liquid emerging from the liquid processing system 40 proceeds, not to the reactor 10 to be recycled, but to storage for low-classification waste.

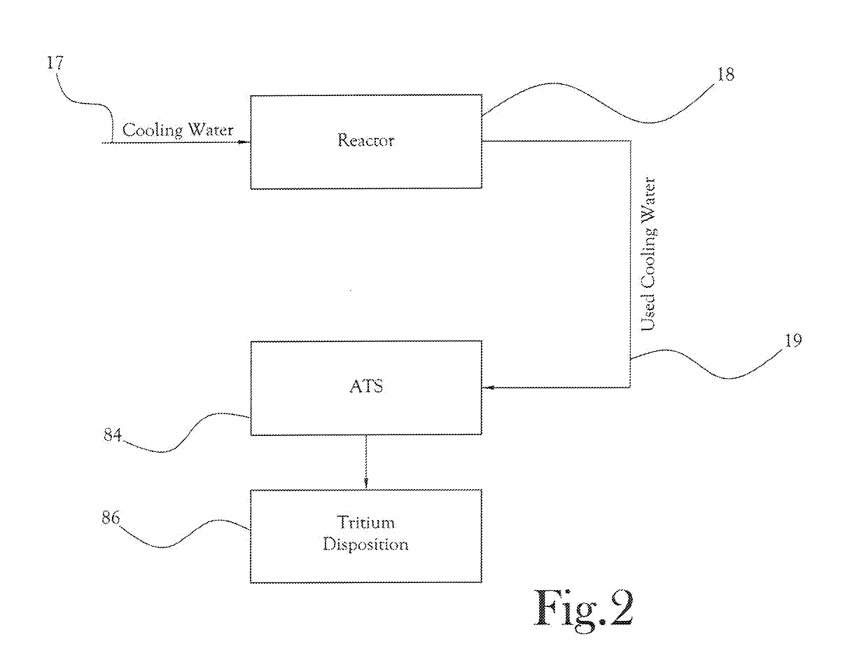

FIG. 2 illustrates another way in which an ATS according to the present general inventive concept is used with a nuclear reactor. In the illustrated embodiment, cooling water 17 supplied to the reactor 18 emerges 19 from the reactor 18 and is passed through an ATS 84 in order to remove tritium contaminants from the water. The separated tritium is diverted to disposal 86, either on-site or off-site, or made into a concentrated product.

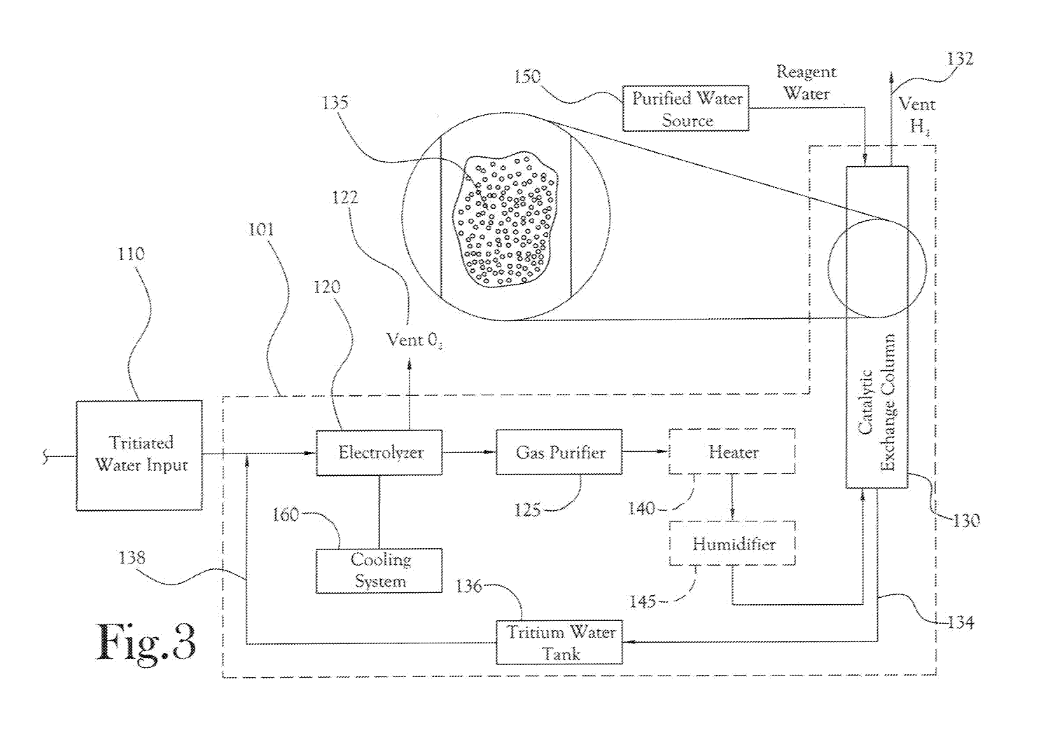

FIG. 3 illustrates a tritium separation system according to an example embodiment of the present general inventive concept. As shown in FIG. 3, in this embodiment, water enters the ATS 101 through an input 110; at this stage in the treatment of the water, the water contains tritium isotopes primarily in the form of tritiated water (e.g. HTO), where at least one of the protonic hydrogen atoms of the water molecule has been replaced by a tritium atom. The water with tritiated water passes into an electrolyzer 120—generally an alkaline electrolyzer, although other electrolyzers are contemplated—where the tritiated water is broken up by electrolysis into a combination of oxygen gas (O₂) and hydrogen gas comprising a number of hydrogen isotopes and isotope combinations (e.g. H₂, HT, T₂). The electrolysis of water generates heat, and therefore a cooling system 160 is connected to the electrolyzer 120 for maintaining the temperature of the electrolyzer 120 and other components of the ATS 101 within acceptable limits. The oxygen gas is diverted and discharged 122 from the ATS 101, while the hydrogen gas is directed to a gas purifier 125, where various contaminants entrained in the gas, such as KOH or another substance from the electrolyzer 120, are removed from the gas. The hydrogen gas passes from the gas purifier 125 into a catalytic exchange column 130; in some embodiments, the hydrogen gas leaving the gas purifier 125 first passes through a heater 140 or a humidifier 145, or both, before entering the catalytic exchange column 130. Within the catalytic exchange column 130, tritium is separated from protonic hydrogen. Hydrogen gas, including gas molecules with tritium constituents (i.e., tritiated hydrogen gas), enters the bottom of the catalytic exchange column 130 and rises through the height of the catalytic exchange column 130. Generally, the hydrogen gas with tritium has been heated before it enters the catalytic exchange column 130. Substantially simultaneously, purified water—distilled or at least deionized—from a purified water source 150 is fed into the top of the catalytic exchange column 130 and allowed to trickle down; this purified water is also called “reagent water” because it reacts with the hydrogen gas with tritium. The catalytic exchange column is packed with granulated palladium 135 or a similar catalyst (shown in the cutaway in the inset view in FIG. 3). As the hydrogen gas rises and the tritium is retained on the catalyst, the falling reagent water in the presence of the catalyst 135 within the catalytic exchange column 130 reacts with the retained tritium to yield tritiated water (e.g., HTO) and hydrogen gas that is substantially free of tritium isotopes (i.e., “detritiated hydrogen”). The detritiated hydrogen is vented 132 from the catalytic exchange column 130, while the tritiated water exits 134 the catalytic exchange column 130 and proceeds to a holding tank 136. In many embodiments, the tritiated water in the holding tank 136 is fed back 138 into the electrolyzer 120 in order to repeat the process of electrolysis and catalytic tritium separation, thereby yielding a tritiated water product with a higher concentration of tritium. Otherwise, the tritiated water proceeds from the holding tank 136 to storage or other disposition (e.g., stabilization and disposal).

Passing tritiated water from a nuclear reactor, or front radioactive waste, through an ATS such as the example illustrated in FIG. 3 and outlined above results in a product of concentrated tritiated water. The ATS minimizes or essentially eliminates the volume of water that includes tritium.

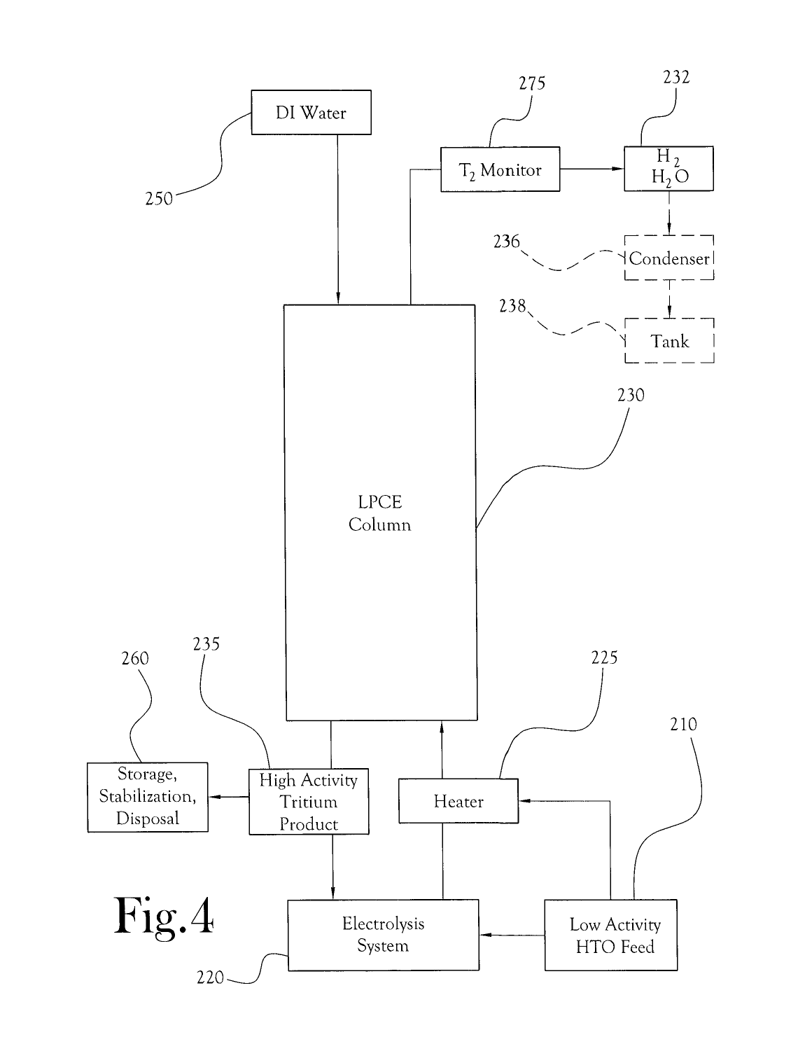

Some embodiments of the present general inventive concept include using an ATS to concentrate tritium in reactor water into a small volume of concentrated tritiated water. FIG. 4 illustrates one example embodiment of the present general inventive concept. In the illustrated example embodiment, a water feed 210 delivers low activity water containing HTO (and other tritiated water compounds, like T₂O) to an electrolysis system 220—generally an alkaline electrolyzer, although other electrolyzers are contemplated—which electrolyzes the tritiated water to produce a combination of oxygen gas (O₂) and hydrogen gas comprising a number of hydrogen isotopes and isotope combinations (e.g. H₂, HT, T₂). The oxygen gas is diverted and discharged from the ATS, while the hydrogen gas is combined with heated water vapor within a heater 225; the mixture of hydrogen gas and water vapor is then directed into the bottom of a liquid phase catalytic exchange column 230 (hereinafter “LPCE column”). (Combining the hydrogen gas with heated water vapor increases the throughput of the system.) A water source 250 delivers deionized water (or, in some embodiments, distilled water, or some other liquid) to the top of the LPCE column 230. Within the LPCE column 230, tritiated gases from the electrolysis system 220 are retained on the catalyst, while protonic hydrogen gas passes through the LPCE column 230 and is expelled as gaseous exhaust 232. As the tritiated gases from the electrolysis system 220 rise through the LPCE column 230 and are retained on the catalyst, the deionized water trickles down the LPCE column 230 and reacts with the retained tritiated gas molecules to form HTO (and, sometimes, T₂O). The newly formed tritiated water product then emerges from the bottom of the LPCE column 230 as a concentrated high activity tritium product 235. In some embodiments, the concentrated high activity tritium product 235 is passed through the electrolysis system 220 and LPCE column 230 multiple times to enhance the concentration of tritium in the concentrated high activity tritium product—i.e., to separate more protonic hydrogen from tritiated hydrogen so as to yield a higher ratio of tritium to protium in the concentrated high activity tritiated water product or waste. In some embodiments, the concentrated high activity tritium product 235 exits the system for storage, stabilization, or disposal 260.

A number of catalysts are contemplated for use in the LPCE column 230. In some embodiments, the catalyst is generally a TEFLON®-coated palladium catalyst, or a catalyst that includes palladium coated with or mixed with a fluorinated polymer, or a catalyst that includes palladium coated with or mixed with a hydrophobic polymer, or a similar catalyst. Other catalysts are contemplated by the present general inventive concept, and the present general inventive concept is not limited to the illustrated example embodiment catalysts.

As noted, the protonic hydrogen gas produced by electrolysis and passed through the LPCE column 230 generally is expelled along with water vapor as gaseous exhaust 232, as shown in FIG. 4. In some embodiments, a tritium monitor 275 measures the tritium content of the exhaust gas as it leaves the LPCE column 230, thus monitoring whether tritium is being retained within the LPCE column 230 by the catalyst. A number of options exist for the disposition of the expelled protonic hydrogen gas exhaust 232. In some embodiments, the hydrogen gas and water vapor optionally are passed through a condenser 236 and then into a storage tank 238. In some embodiments, the hydrogen gas is used as fuel. In some embodiments, the hydrogen gas is recombined with oxygen to form water. In some embodiments, the hydrogen gas is burned.

Multiple options exist for the further disposition of the tritium after is separated and concentrated by the ATS as in the illustrated embodiment in FIG. 4. In some embodiments, the concentrated tritiated water is buried in canister or placed into long-term storage in canister. In some embodiments, tritium gas is recovered from the concentrated tritiated water. FIG. 6 illustrates one example embodiment of an ATS combined with a system to recover tritium gas from concentrated tritiated water. In the illustrated embodiment, a water feed 410 delivers low activity water containing HTO (and other tritiated water compounds, like T₂O) to a distribution pump 415 and then to an electrolysis system 420, which electrolyzes the tritiated water to produce a combination of oxygen gas (O₂) and hydrogen gas comprising a number of hydrogen isotopes and isotope combinations (e.g. H₂, HT, T₂). The oxygen gas is divested and discharged from the ATS 442, while the hydrogen gas generally is combined with heated water vapor and directed into the bottom of a LPCE column 430. A water source 450 delivers deionized water (or “purge water”) to the top of the LPCE column 430. Within the LPCE column 430, tritiated gases are retained on the catalyst, white protonic hydrogen gas passes through the LPCE column 430 and is expelled as gaseous exhaust 432. In some embodiments, the hydrogen gas and water vapor optionally are passed through a condenser 436 and then into a storage tank 438. As the tritiated gases rise through the LPCE column 430 and are retained on the catalyst, the purge water trickles down the LPCE column 430 and reacts with the retained tritiated gas molecules to form HTO (and, sometimes, T₂O). The newly formed tritiated water product then emerges from the bottom of the LPCE column 430 as a concentrated high activity tritiated water product 435. Then, the concentrated high activity tritiated water product 435 is passed through the distribution pump 415 and electrolysis system 420 to again separate the oxygen atoms from the protium and tritium atoms. The electrolytically separated oxygen gas is expelled 442, and the protium and tritium are directed toward an isotope separation system 482, where protonic hydrogen gas 484 and tritium gas 486 are separated for further disposition. Concentrated tritium gas has numerous applications, as will be known to those in the art.

Thus, in some of the several example embodiments of the present general inventive concept, systems, methods, and processes for a high throughput, low concentration processing of low activity tritiated light water include the electrolysis of at least some of the tritiated water to produce hydrogen and tritium gas. The hydrogen and tritium gas produced by electrolysis are combined with heated water vapor and passed through a LPCE column, which generally includes a catalyst that includes palladium coated with a hydrophobic polymer. As the hydrogen and tritium gas, along with heated water vapor, rise through the LPCE column, the tritium is retained on the catalyst. Deionized wash water passes down the column (i.e., in the opposite direction of the flow of the hydrogen gas and heated water vapor) and carries the retained tritium out of the LPCE column. The tritium, combined with the deionized wash water, is thereby collected as a high-activity tritium waste product with substantially less volume than the original volume of low activity tritiated light water. The water vapor and hydrogen gas, substantially free of tritium, are exhausted as effluent. Some embodiments of the present general inventive concept include various treatments of the hydrogen effluent.

Generally, in some example embodiments of the present general inventive concept, the molar gas flow rate of the hydrogen and tritium gas, along with heated water vapor, rising through the LPCE column is greater than the molar liquid flow rate of the deionized wash water travelling down through the LPCE columns.

In some example embodiments of the present general inventive concept, the composition or component ratio of the mixture of hydrogen gas and water vapor is adjusted to comply with emission guidelines while still maximizing throughput.

The present general inventive concept is not limited to the illustrated embodiments.

While the present general inventive concept has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A system for high throughput separation and concentration of tritium from tritiated waste water in light water nuclear reactors, comprising:
an electrolysis system to electrolyze tritiated waste water to produce oxygen gas, hydrogen gas and tritium gas;
a heater to heat water vapor;
a liquid phase catalytic exchange column to receive a mixture of hydrogen gas and tritium gas from said electrolysis system and heated water vapor from said heater, said liquid phase catalytic exchange column including a catalyst to retain tritium gas from said mixture as said mixture passes through said liquid phase catalytic exchange column;
a deionized water source to provide deionized wash water to said liquid phase catalytic exchange column in order to remove said tritium from said catalyst, so that said deionized wash water and said tritium emerge from said liquid phase catalytic exchange column as a concentrated tritium waste product; and
a gaseous exhaust subsystem to carry away hydrogen gas and water vapor as gaseous exhaust from said liquid phase catalytic exchange column.

2. The system of claim 1 wherein said catalyst includes palladium.

3. The system of claim 2 wherein said catalyst includes palladium coated with a hydrophobic material.

4. The system of claim 3 wherein said catalyst includes palladium coated with a hydrophobic polymer.

5. The system of claim 4 wherein said catalyst includes palladium coated with a fluoropolymer.

6. The system of claim 5 wherein said catalyst includes palladium coated with a polytetrafluoroethylene.

7. The system of claim 1 further comprising a tritium monitor to monitor the tritium content of the gaseous exhaust within said gaseous exhaust subsystem.

8. The system of claim 1 further comprising a condenser to condense at least some of the gaseous exhaust.

9. The system of claim 1 further comprising a stabilization subsystem for treating said concentrated tritium waste product.

10. A method for high throughput separation and concentration of tritium from tritiated waste water in light water nuclear reactors, comprising: electrolyzing tritiated water to produce hydrogen and tritium gas;
combining hydrogen and tritium gas produced by electrolysis with heated water vapor to produce a mixture;
passing the mixture through a liquid phase catalytic exchange column that includes a catalyst configured to retain tritium from the mixture,
passing deionized wash water through said liquid phase catalytic exchange column to remove the tritium from said catalyst;
collecting the tritium and the deionized wash water as a high activity tritium waste product; and
expelling water vapor and hydrogen gas as effluent.

11. The method of claim 10 wherein said catalyst includes palladium.

12. The method of claim 11 wherein said catalyst includes palladium coated with a hydrophobic polymer.

13. The method of claim 12 wherein said catalyst includes palladium coated with a fluoropolymer.

14. The method of claim 13 wherein said catalyst includes palladium coated with a polytetrafluoroethylene.

15. The method of claim 10 further comprising monitoring the tritium content of the effluent with a tritium monitor.

16. The method of claim 10 further comprising condensing at least some of the effluent.

17. The method of claim 10 further comprising stabilizing the high activity tritium waste product.
